(19) United States
(12) Patent Application Publication
(10) Pub. No.: US 2025/0157070 A1
(43) Pub. Date: May 15, 2025

(54) NOTIFICATION ASSISTANCE SYSTEM, NOTIFICATION ASSISTANCE METHOD, AND COMPUTER-READABLE STORAGE MEDIUM

(71) Applicant: NEC Corporation, Minato-ku, Tokyo (JP)

(72) Inventors: Takeshi HISHIYAMA, Tokyo (JP); Tetsuhiro TSUNODA, Tokyo (JP); Toshihiro ENDO, Tokyo (JP)

(73) Assignee: NEC Corporation, Minato-ku, Tokyo (JP)

(21) Appl. No.: 18/839,473

(22) PCT Filed: Feb. 22, 2022
(86) PCT No.: PCT/JP2022/007280

§ 371 Date: Aug. 19, 2024

(51) Int. Cl. G06T 7/70; G06T 7/50; G06V 20/50; G08B 25/00; H04N 23/60; H04N 23/63

(52) U.S. Cl. CPC G06T 7/70; G06T 7/50; G06V 20/50; G08B 25/00; H04N 23/633; H04N 23/64; G06T 2207/30244

(57) ABSTRACT

A notification assistance system according to one aspect of the present disclosure includes: an acquisition circuit for acquiring captured images from a communication terminal in the possession of a notifying party; a detection circuit for detecting a plurality of objects included in the captured images; an identification circuit for identifying location information corresponding to each of the plurality of detected objects; and an estimation circuit for estimating the location of the notifying party on the basis of the identified location information.

### TECHNICAL FIELD

The present disclosure relates to a technique for assisting a response at the time of notification.

### BACKGROUND ART

When an accident or the like occurs, a person at the scene of the accident makes an emergency call to a police station, a fire department, or the like according to the situation. The operator in the command room at the notification destination to which the emergency call has been received usually grasps the situation by voice from the notifying party. For example, the operator verbally asks the notifying party the current location.

In order to identify the current location of the notifying party, it is conceivable to acquire location information measured using a positioning system such as a global navigation satellite system (GNSS) from a communication terminal owned by the notifying party in a command room of the notification destination. For example, PTL 1 discloses acquisition of location information from a mobile terminal owned by a notifying party. Specifically, it is disclosed that a mobile terminal acquires location information using a global positioning system (GPS), and automatically transmits the location information to an emergency institution such as police in an emergency call.

In relation to acquisition of location information, PTL 2 discloses that a position of a mobile terminal is identified based on an image captured by the mobile terminal. Specifically, the technique disclosed in PTL 2 causes a notifying party to photograph a road sign, and further inquires about what is present as a surrounding landmark. Then, in the technology, the position is identified based on the captured image and the information regarding the landmark as the answer to the question.

### CITATION LIST

### Patent Literature

PTL 1: JP 2007-189363 A
PTL 2: JP 2007-150681 A

### SUMMARY OF INVENTION

### Technical Problem

At the time of emergency call, the operator in the command room as the notification destination is required to quickly grasp the current location of the notifying party. Here, for example, in a case where the current location of the notifying party is a place unfamiliar to the notifying party, the notifying party may not know the current location. There is a possibility that the notifying party falls into a panic at the time of emergency call and cannot quickly grasp the current location.

The technique disclosed in PTL 1 is based on the premise that a positioning system is used in a communication terminal. Therefore, when the notifying party owns a communication terminal that is not supported by the positioning system, the current location of the notifying party cannot be identified by the method. Even if the notifying party owns a communication terminal that can use the positioning system, the accuracy of the positioning system may decrease depending on the place where the notifying party is located.

In the technique disclosed in PTL 2, it is necessary to cause the notifying party to answer a question. For example, when the notifying party falls into a panic, there is a possibility that the notifying party cannot appropriately answer the question.

The present disclosure has been made in view of the above problems, and an object thereof is to provide a notification assistance system and the like capable of assisting transmission of location information to a notification destination.

### Solution to Problem

A notification assistance system according to one aspect of the present disclosure includes an acquisition means for acquiring a captured image from a communication terminal owned by a notifying party, a detection means for detecting a plurality of objects included in the captured image, an identification means for identifying location information relevant to each of the plurality of detected objects, and an estimation means for estimating a position of the notifying party based on the identified location information.

A notification assistance method according to one aspect of the present disclosure includes acquiring a captured image from a communication terminal owned by a notifying party, detecting a plurality of objects included in the captured image, identifying location information relevant to each of the plurality of detected objects, and estimating a position of the notifying party based on the identified location information.

A computer-readable storage medium according to an aspect of the present disclosure stores a program causing a computer to execute acquiring a captured image from a communication terminal owned by a notifying party, detecting a plurality of objects included in the captured image, identifying location information relevant to each of the plurality of detected objects, and estimating a position of the notifying party based on the identified location information.

### Advantageous Effects of Invention

According to the present disclosure, it is possible to assist transmission of location information to a notification destination.

### BRIEF DESCRIPTION OF DRAWINGS

FIG. 1 is a diagram schematically illustrating an example of a notification mechanism of the present disclosure.

FIG. 2 is a block diagram illustrating an example of a functional configuration of a notification assistance system according to a first example embodiment of the present disclosure.

FIG. 3 is a flowchart for explaining an example of operation of the notification assistance system according to the first example embodiment of the present disclosure.

FIG. 4 is a block diagram schematically illustrating an example of a functional configuration of a notification assistance system according to a second example embodiment of the present disclosure.

FIG. 5 is a diagram illustrating an example of a captured image according to the second example embodiment of the present disclosure.

FIG. 6 is a diagram illustrating an example of a map on which identified location information is superimposed according to the second example embodiment of the present disclosure.

FIG. 7A is a first diagram for explaining an example of a positional relationship between an object and a notifying party according to the second example embodiment of the present disclosure.

FIG. 7B is a second diagram for explaining an example of a positional relationship between an object and a notifying party according to the second example embodiment of the present disclosure.

FIG. 8 is a sequence diagram for explaining an example of operation of a notification assistance system 100 according to the second example embodiment of the present disclosure.

FIG. 9 is a diagram illustrating an example of an imaging screen according to Modification 4 of the present disclosure.

FIG. 10 is a block diagram illustrating an example of a functional configuration of a notification assistance system according to a third example embodiment of the present disclosure.

FIG. 11 is a diagram illustrating an example of output information according to the third example embodiment of the present disclosure.

FIG. 12 is a diagram illustrating another example of the output information according to the third example embodiment of the present disclosure.

FIG. 13 is a flowchart for explaining an example of operation of the notification assistance system according to the third example embodiment of the present disclosure.

FIG. 14 is a block diagram illustrating an example of a hardware configuration of a computer device that implements the notification assistance systems according to the first, second, and third example embodiments of the present disclosure.

### EXAMPLE EMBODIMENT

Hereinafter, example embodiments of the present disclosure will be described with reference to the drawings.

### First Example Embodiment

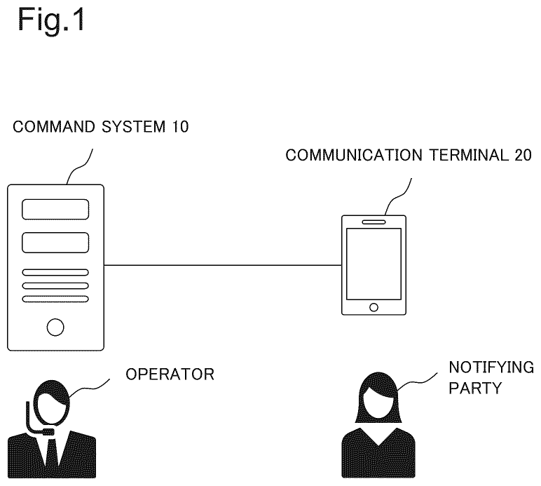

First, a notification mechanism will be described. FIG. 1 is a diagram schematically illustrating an example of a notification mechanism. A communication terminal 20 and a command system 10 are communicably connected via a wireless or wired network. The notifying party performs notification by inputting a predetermined telephone number or the like using the communication terminal 20, for example. The communication terminal 20 is, for example, a mobile terminal such as a mobile phone, a smartphone, and a tablet terminal. The present invention is not limited to this example, and the communication terminal may be a personal computer. The communication terminal 20 is a terminal having at least a function of performing notification and a function of performing photographing.

The notification is connected to the command system 10 in the command room as a notification destination. The command system 10 may be, for example, a server device or devices including the server device. The command room indicates an organization that commands a target (for example, a police officer, a fire brigade, an ambulance team, and the like) to be dispatched to the site according to the content of the notification. The operator in the command room makes a call with the notifying party via the command system 10. Then, the operator gives an instruction to the notifying party based on the information obtained from the notifying party, or gives an instruction to a target to be dispatched to the site using the command system 10. The notification assistance system of the present disclosure is used in a situation where such notification is performed as an example.

Next, an outline of the notification assistance system of the present disclosure will be described.

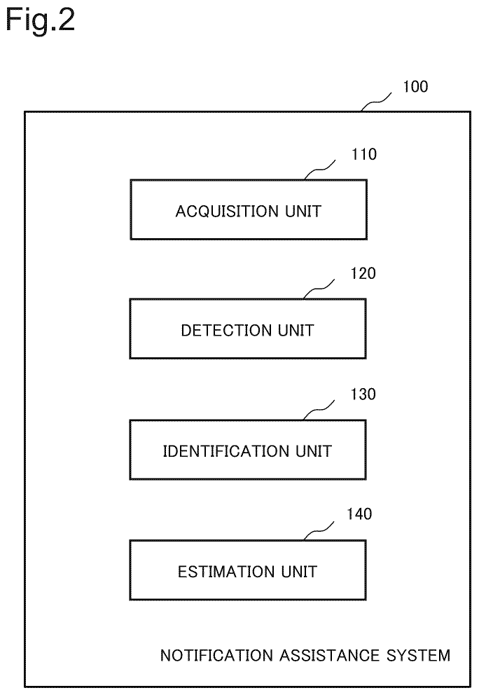

FIG. 2 is a block diagram illustrating an example of a functional configuration of a notification assistance system 100. The notification assistance system 100 is incorporated in, for example, the command system 10. The present invention is not limited thereto, and the notification assistance system 100 may be incorporated in the communication terminal 20 or may be a system implemented across the communication terminal 20 and the command system 10. The notification assistance system 100 may be implemented in a device different from the command system 10 that can communicate with the communication terminal 20.

As illustrated in FIG. 2, the notification assistance system 100 includes an acquisition unit 110, a detection unit 120, an identification unit 130, and an estimation unit 140.

The acquisition unit 110 acquires an image captured by the communication terminal 20. For example, when the communication terminal 20 makes a notification, the communication terminal 20 captures an image by the operation of the notifying party. At this time, the notification assistance system 100 may start a camera mounted on the communication terminal 20 by transmitting a signal requesting imaging to the communication terminal 20. The communication terminal 20 may activate the camera when the communication terminal 20 receives the input of the notifying party. For example, the acquisition unit 110 acquires a captured image generated by capturing from the communication terminal 20. In this manner, the acquisition unit 110 acquires the captured image from the communication terminal 20 owned by the notifying party. The acquisition unit 110 is an example of an acquisition means.

The detection unit 120 detects a plurality of objects included in the captured image. For example, the detection unit 120 detects an object based on a feature amount extracted from the captured image. In this case, for example, a database including information in which a feature amount and object information are associated with each other is stored in a storage device (not illustrated) included in the notification assistance system 100 or an external device communicable with the notification assistance system 100. The detection unit 120 collates the feature amount extracted from the captured image with the feature amount included in the database. Then, in a case where the collation is matched, the detection unit 120 may detect the object by identifying the object information associated with the matched feature amount. The object information may be, for example, a name of an object or a code for discriminating the object. The object information may be any information that can discriminate an object.

Various methods can be applied as the object detection method. For example, the object detection method may be a method based on various machine learning models such as deep learning. For example, the detection unit 120 extracts a candidate of a region including an object from the captured image, and calculates a feature amount in the candidate of each region by a convolutional neural network (CNN) or the like. Then, the detection unit 120 may detect an object included in a candidate of each region by using a classifier such as a support vector machine (SVM) with respect to the calculated feature amount. The object detection method may be any method as long as the object information of the object included in the captured image can be identified.

In this manner, the detection unit 120 detects a plurality of objects included in the captured image. The detection unit 120 is an example of a detection means.

The identification unit 130 identifies location information relevant to the detected object. For example, the identification unit 130 identifies the location information based on the object information regarding the detected object. More specifically, a database including information in which object information and location information are associated with each other is stored in advance in a storage device (not illustrated) included in the notification assistance system 100 or an external device communicable with the notification assistance system 100. The identification unit 130 may identify the location information associated with the object information similar to the object information on the detected object from the database. Various methods can be applied as a method of identifying the location information. For example, the identification unit 130 may identify the location information by searching the object information with a search engine.

In this manner, the identification unit 130 identifies the location information relevant to each of the plurality of detected objects. The identification unit 130 is an example of an identification means.

The estimation unit 140 estimates the position of the notifying party. Specifically, the estimation unit 140 estimates the position of the notifying party based on each piece of the identified location information, that is, each piece of the location information of the detected object. For example, the estimation unit 140 may estimate any one of the identified location information as the position of the notifying party. For example, the estimation unit 140 may exclude location information that is separated from other location information by a predetermined distance or more, that is, location information that becomes an outlier from the identified location information. Then, the estimation unit 140 may estimate any piece of the location information other than the excluded location information among the identified location information as the position of the notifying party. Furthermore, the estimation unit 140 may estimate the position of the notifying party based on, for example, the positional relationship of the detected object on the captured image and the identified location information. For example, the position of the notifying party may be estimated from location information of an object appearing in front of the captured image among the plurality of objects based on a depth map generated from the captured image.

In this manner, the estimation unit 140 estimates the position of the notifying party based on each piece of the identified location information. However, the estimation unit 140 is an example of an estimation means.

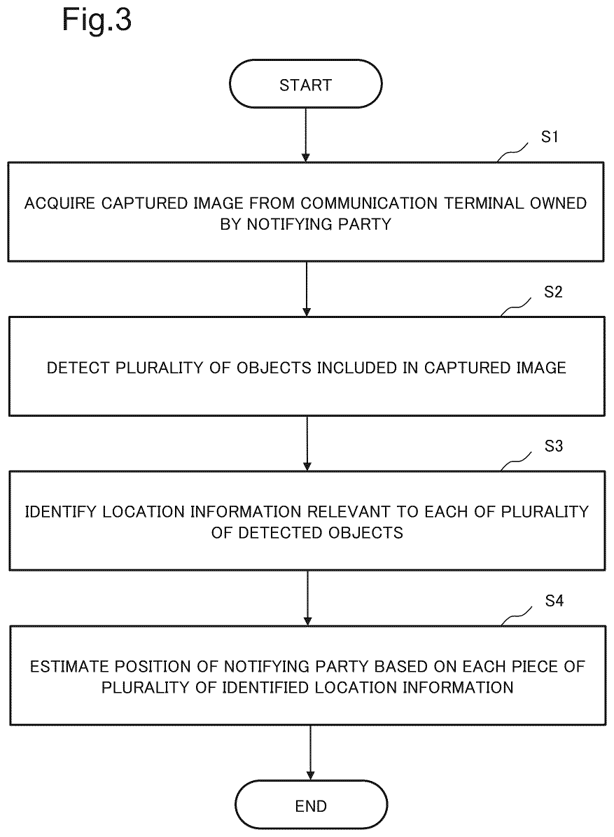

Next, an example of an operation of the notification assistance system 100 will be described with reference to FIG. 3. In the present disclosure, each step of the flowchart is expressed using a number assigned to each step, such as “S1”.

FIG. 3 is a flowchart for explaining an example of an operation of the notification assistance system 100. The acquisition unit 110 acquires the captured image from the communication terminal 20 owned by the notifying party (S1). The detection unit 120 detects a plurality of objects included in the captured image (S2). The identification unit 130 identifies location information relevant to each of the plurality of detected objects (S3). The estimation unit 140 estimates the position of the notifying party based on each piece of the identified location information (S4).

As described above, the notification assistance system 100 according to the first example embodiment acquires the captured image from the communication terminal 20 owned by the notifying party and detects a plurality of objects included in the captured image. Then, the notification assistance system 100 identifies location information relevant to each of the plurality of detected objects and estimates the position of the notifying party based on each piece of the identified location information. As a result, the notification assistance system 100 can provide the position of the notifying party estimated from the image captured by the communication terminal 20. Therefore, the operator can quickly grasp the current location of the notifying party. Furthermore, since the notification assistance system 100 estimates the position of the notifying party from the image captured by the communication terminal 20, the position of the notifying party can be estimated even in a case where the communication terminal 20 cannot use a positioning system that measures its own position. The notification assistance system 100 may not necessarily cause a question for estimating the position of the notifying party to be answered. As described above, the notification assistance system 100 according to the first example embodiment can assist transmission of the location information to the notification destination.

### Second Example Embodiment

Next, a notification assistance system according to a second example embodiment will be described. In the second example embodiment, the notification assistance system 100 described in the first example embodiment will be described in more detail. The description of contents overlapping with the first example embodiment will be partially omitted.

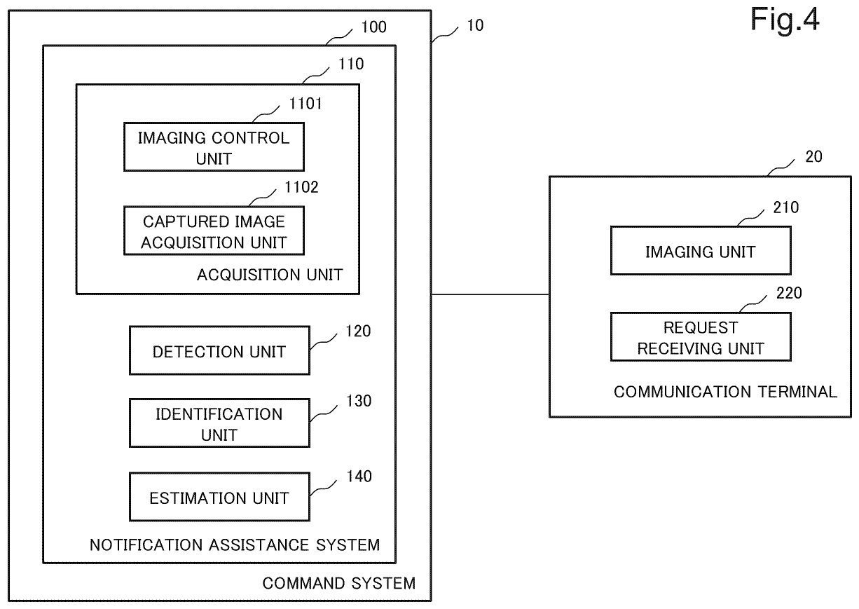

FIG. 4 is a block diagram illustrating an example of a functional configuration of the notification assistance system 100. As illustrated in FIG. 4, for example, the notification assistance system 100 is included in the command system 10. As described above, the configuration of the notification assistance system 100 is not limited to this example. In the present disclosure, an example in which the notification assistance system 100 is provided in the command system 10 will be mainly described.

The notification assistance system 100 includes an acquisition unit 110, a detection unit 120, an identification unit 130, and an estimation unit 140. The communication terminal 20 includes an imaging unit 210 and a request receiving unit 220.

The acquisition unit 110 includes an imaging control unit 1101 and a captured image acquisition unit 1102. The imaging control unit 1101 causes the communication terminal 20 to capture an image in response to the notification. For example, when the communication terminal 20 makes a notification, the imaging control unit 1101 detects the notification. Then, the imaging control unit 1101 transmits an imaging request. When the request receiving unit 220 of the communication terminal 20 receives the imaging request, the imaging unit 210 of the communication terminal 20 starts imaging. The imaging unit 210 performs imaging and generates a captured image. That is, the imaging unit 210 has a function of a camera mounted on the communication terminal 20. In this manner, the imaging control unit 1101 causes the communication terminal 20 to start imaging in response to the detection of the notification from the communication terminal 20. The imaging control unit 1101 is an example of an imaging control means.

The captured image acquisition unit 1102 acquires the captured image from the communication terminal 20. For example, imaging is performed in the imaging unit 210 in response to an imaging request from the imaging control unit 1101. The imaging unit 21 transmits the generated captured image to the notification assistance system 100. The captured image acquisition unit 1102 acquires the captured image transmitted by the imaging unit 21. In this manner, the captured image acquisition unit 1102 acquires, from the communication terminal 20, the captured image by imaging started by the imaging control unit 1101. The captured image acquisition unit 1102 is an example of a captured image acquisition means.

Here, as a method of acquiring the captured image by the captured image acquisition unit 1102, various methods can be considered. For example, it is assumed that notification by the communication terminal 20 is performed through a telephone line. That is, it is assumed that the notification is made through a line through which a captured image cannot be transmitted. The imaging control unit 1101 transmits a message using, for example, the phone number of the communication terminal 20. At this time, the imaging control unit 1101 may transmit a message using a short message service (SMS). The message includes, for example, a uniform resource locator (URL). When the URL of the message is opened in the communication terminal 20, data communication between the communication terminal 20 and the notification assistance system 100 (or the command system 10) is started. For example, the imaging control unit 1101 may transmit such a message as an imaging request. The request receiving unit 220 receives such a message as an imaging request. Then, data communication is started by opening the URL included in the message by the operation of the notifying party. The data communication at this time may be implemented by, for example, Web Real Time Communication (WebRTC). That is, when the URL included in the message is opened by the operation of the notifying party, data communication via a browser may be performed in the notification assistance system 100 (or the command system 10) and the communication terminal 20. The imaging unit 210 transmits the captured image using the data communication started in this way. The captured image acquisition unit 1102 acquires a captured image using the data communication.

For example, it is assumed that the notification by the communication terminal 20 is performed using data communication instead of a telephone line. That is, it is assumed that notification is made by data communication that enables transmission of a captured image. In this case, when detecting the notification, the imaging control unit 1101 transmits an imaging request to the communication terminal 20. The imaging request at this time may be a signal for controlling the imaging unit 210 of the communication terminal 20. That is, the imaging control unit 1101 may activate the function of the camera of the communication terminal 20. Then, the imaging unit 210 transmits the captured image to the notification assistance system 100 using the data communication. The captured image acquisition unit 1102 acquires a captured image using the data communication.

The detection unit 120 detects a plurality of objects from the acquired captured image. The object is a mark capable of identifying a position. For example, the object may be a signboard and a sign, or may be a landmark such as a parking lot, a store, a characteristic building, a bronze statue, or a monument. The object may be a sign, a utility pole, a manhole, a vending machine, a display plate indicating a management number attached thereto, or the like.

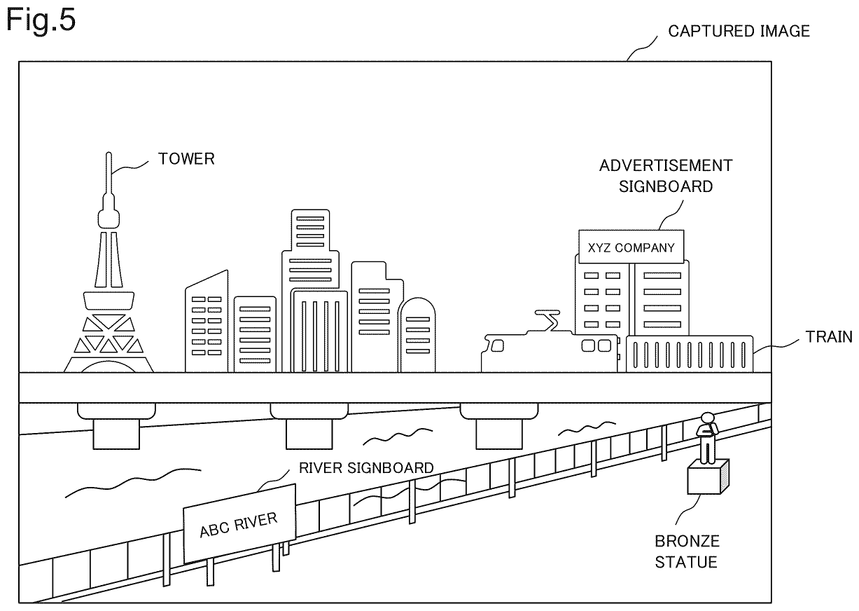

FIG. 5 is a diagram illustrating an example of a captured image. In the example of FIG. 5, buildings, a river, a train, an overpass, and the like are shown in the captured image. For example, the detection unit 120 detects a tower, a river signboard, an advertisement signboard, and a bronze statue from the captured image. That is, the detection unit 120 identifies object information of a tower, a river signboard, an advertisement signboard, and a bronze statue.

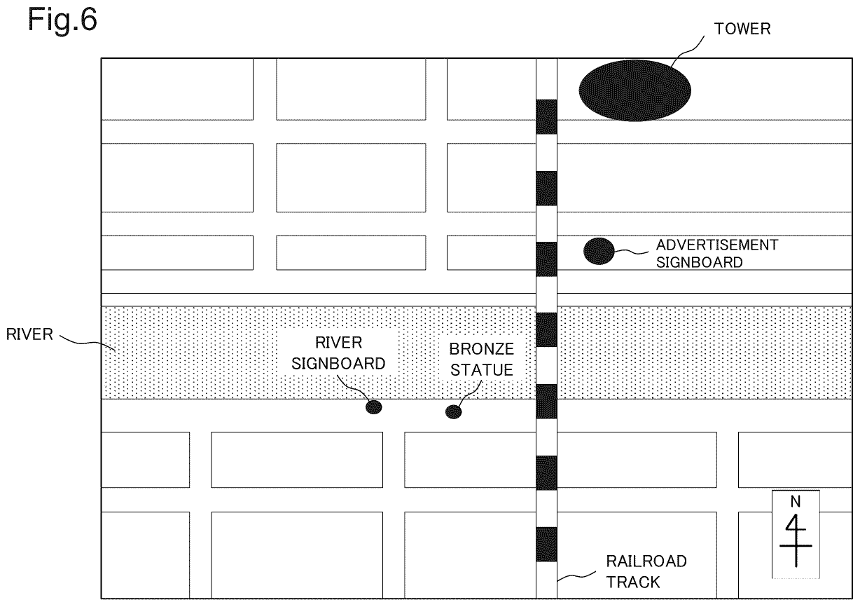

The identification unit 130 identifies the location information of the object detected by the detection unit 120. In the example of FIG. 5, it is assumed that the detection unit 120 detects a tower, a river signboard, an advertisement signboard, and a bronze statue. At this time, the identification unit 130 identifies the location information of each of the tower, the river signboard, the advertisement signboard, and the bronze statue. For example, the identification unit 130 identifies the location information associated with the object information relevant to each of the tower, the river signboard, the advertisement signboard, and the bronze statue from the database including the information in which the object information and the location information are associated with each other. Here, the identification unit 130 may output the identified location information on the map in a superimposed manner. FIG. 6 is a diagram illustrating an example of a map on which the identified location information is superimposed. More specifically, FIG. 6 illustrates a diagram in which location information of an object detected from the captured image of FIG. 5 is superimposed on a map. In the example of FIG. 6, the position of the detected object is indicated by a point. In FIG. 6, hatched portions indicate rivers, and striped lines indicate railroad tracks.

The estimation unit 140 estimates the position of the notifying party based on the identified location information. For example, in the example of FIG. 5, it is assumed that the detection unit 120 detects a tower, a river signboard, an advertisement signboard, and a bronze statue, and the identification unit 130 identifies location information of each of the tower, the river signboard, the advertisement signboard, and the bronze statue. At this time, the estimation unit 140 estimates the position of the notifying party based on the location information of each of the tower, the river signboard, the advertisement signboard, and the bronze statue. For example, the estimation unit 140 may estimate a position indicating the periphery of any one of a tower, a river signboard, an advertisement signboard, and a bronze statue as the position of the notifying party.

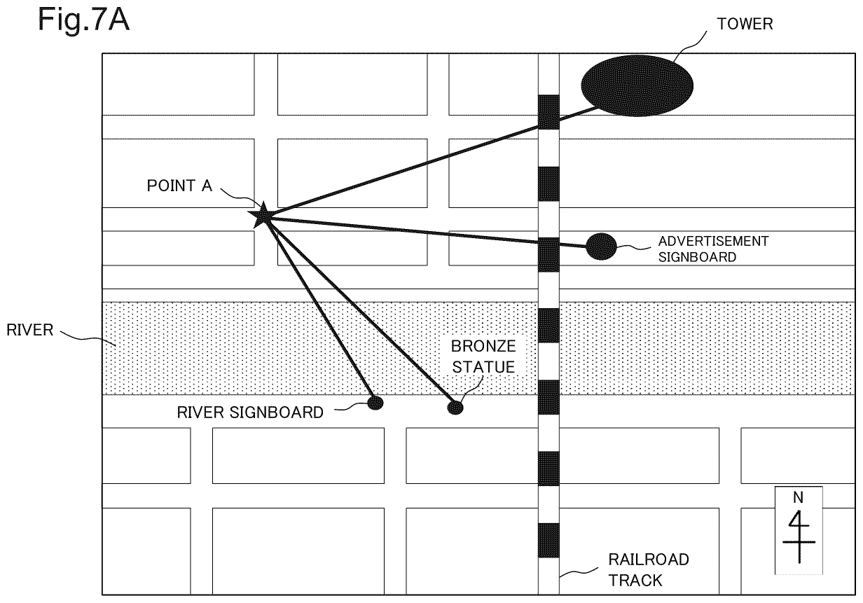

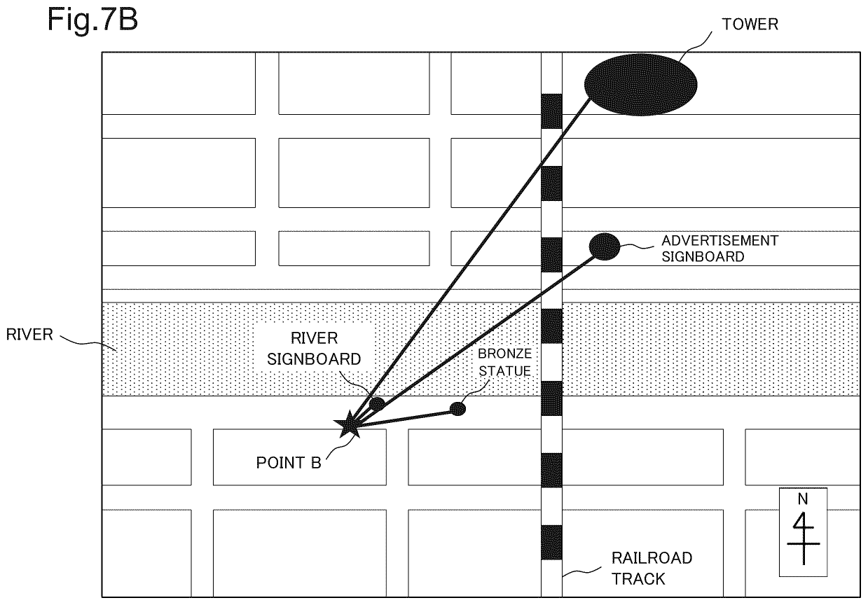

The estimation unit 140 may estimate the position of the notifying party from the positional relationship of the location information of the detected object and the positional relationship of the detected object on the captured image. For example, in the example of FIG. 5, the detected objects appear in the order of a tower, a river signboard, an advertisement signboard, and a bronze statue from the left side of the captured image. That is, the notifying party is at a position where the tower, the river signboard, the advertisement signboard, and the bronze statue can be seen in this order from the left side. An example of a method of estimating the position of the notifying party in this case will be described with reference to FIGS. 7A and 7B. FIG. 7A is a first diagram for explaining an example of a positional relationship between an object and a notifying party. FIG. 7B is a second diagram for explaining an example of the positional relationship between the object and the notifying party. As illustrated in FIGS. 7A and 7B, each of the detected objects is indicated by a dot on the map. FIG. 7A illustrates a line segment connecting point A and each of the detected objects. It is assumed that there is a notifying party at point A. At this time, as indicated by a line segment, objects should appear in the captured image in the order of a tower, an advertisement signboard, a bronze statue, and a river signboard from the left side. Therefore, the estimation unit 140 can estimate that there is no notifying party in the vicinity of point A. On the other hand, FIG. 7B illustrates a line segment connecting point B and each of the detected objects. Assuming that there is a notifying party at point B, the captured image should show objects in the order of a tower, a river signboard, an advertisement signboard, and a bronze statue from the left side. Therefore, the estimation unit 140 can estimate that there is a high possibility that the notifying party is near point B. In this manner, the estimation unit 140 can estimate the range in which the captured image acquired by the acquisition unit 110 can be captured. Then, for example, the estimation unit 140 may estimate the estimated range as the position of the notifying party. The estimation unit 140 may identify an object closest to the estimated range among the detected objects. Then, the estimation unit 140 may estimate, as the position of the notifying party, a range within the estimated range in which the distance from the identified object is within a predetermined value. In this manner, the estimation unit 140 may estimate the position of the notifying party based on the positional relationship of the identified location information and the positional relationship on the captured images of the plurality of detected objects.

The method of estimating the position of the notifying party is not limited to this example. For example, the estimation unit 140 may extract information regarding the distance from the communication terminal 20 to each of the plurality of detected objects from the captured image. At this time, for example, the estimation unit 140 generates a depth map from the captured image. The depth map is information related to the distance from the camera to the object relevant to each pixel of the image. Then, the estimation unit 140 acquires the distance from the communication terminal 20 to each of the detected objects by using the depth map. In this manner, the estimation unit 140 may extract the information regarding the distance from the captured image.

For example, the estimation unit 140 may estimate, as the position of the notifying party, the position indicated by the location information of the object having the shortest distance to the communication terminal among the detected objects. The estimation unit 140 may estimate, as the position of the notifying party, a predetermined range including the position indicated by the location information of the object having the shortest distance to the communication terminal 20 among the detected objects. In this manner, the estimation unit 140 may estimate the position of the notifying party based on the positional relationship of the identified location information and the information regarding the distance from the communication terminal 20 to each of the plurality of objects extracted from the captured image captured by the communication terminal 20.

The method of generating the depth map may be various methods. For example, it is assumed that the communication terminal 20 includes a multi-view camera, and the imaging unit 210 performs imaging using the multi-view camera. At this time, the captured image acquisition unit 1102 acquires a plurality of captured images captured by the multi-view camera. For example, the estimation unit 140 may generate a depth map from a plurality of acquired captured images. The method of generating the depth map may be a method using machine learning. For example, the relationship between the captured image and the depth map (that is, correct data) relevant to the captured image is learned in advance. The estimation unit 140 may generate the depth map from the acquired captured image using the model learned in this manner.

### [Operation Example of Notification Assistance System 100]

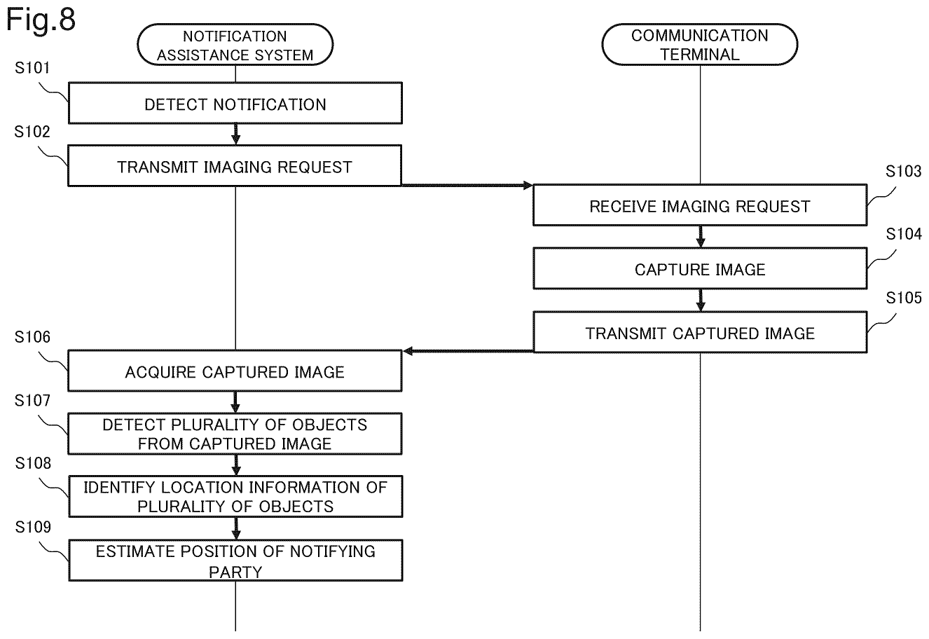

Next, an example of an operation of the notification assistance system 100 will be described with reference to FIG. 8.

FIG. 8 is a sequence diagram for explaining an example of the operation of the notification assistance system 100. First, the imaging control unit 1101 detects a notification (S101). Then, the imaging control unit 1101 transmits an imaging request to the communication terminal 20 (S102). Then, the request receiving unit 220 receives the imaging request (S103). The imaging unit 210 captures an image in response to the imaging request being received by the request receiving unit 220 (S104). The imaging unit 210 transmits the captured image to the notification assistance system 100 (S105).

The captured image acquisition unit 1102 acquires a captured image (S106). The detection unit 120 detects a plurality of objects from the acquired captured image (S107). The identification unit 130 identifies the location information of the plurality of detected objects (S108). Then, the estimation unit 140 estimates the position of the notifying party based on the identified location information (S109).

As described above, the notification assistance system 100 according to the second example embodiment acquires the captured image from the communication terminal 20 owned by the notifying party and detects a plurality of objects included in the captured image. Then, the notification assistance system 100 identifies location information relevant to each of the plurality of detected objects and estimates the position of the notifying party based on each piece of the identified location information. As a result, the notification assistance system 100 can provide the position of the notifying party estimated from the image captured by the communication terminal 20. Therefore, the operator can quickly grasp the current location of the notifying party. Furthermore, since the notification assistance system 100 estimates the position of the notifying party from the image captured by the communication terminal 20, the position of the notifying party can be estimated even in a case where the communication terminal 20 cannot use a positioning system that measures its own position. The notification assistance system 100 may not necessarily cause a question for estimating the position of the notifying party to be answered. As described above, the notification assistance system 100 according to the second example embodiment can assist transmission of the location information to the notification destination.

The notification assistance system 100 according to the second example embodiment may estimate the position of the notifying party based on the positional relationship of the identified location information and the positional relationship on the captured images of the plurality of detected objects. The notification assistance system 100 may estimate the position of the notifying party based on the positional relationship of the identified location information and the information regarding the distance from the communication terminal 20 to each of the plurality of objects extracted from the captured image captured by the communication terminal 20. As a result, the notification assistance system 100 can improve the accuracy of estimating the position of the notifying party.

### Modification 1

The functional configuration of the communication terminal 20 may be included in the notification assistance system 100. That is, the notification assistance system 100 may include the imaging unit 210 and the request receiving unit 220.

### Modification 2

The notification assistance system 100 may be provided in the communication terminal 20. That is, the acquisition unit 110, the detection unit 120, the identification unit 130, and the estimation unit 140 may be included in the communication terminal 20. At this time, the imaging control unit 1101 may detect that the communication terminal 20 has made a notification, and cause the imaging unit 210 to start imaging in response to the start of data communication between the communication terminal 20 and the command system 10. The captured image acquisition unit 1102 acquires the captured image photographed by the imaging unit 210. Then, the estimation unit 140 may transmit information indicating the estimated position of the notifying party to the command system 10.

### Modification 3

In a case where there is a plurality of object candidates detected from the same region of the captured image, the detection unit 120 may detect the plurality of candidates. For example, the detection unit 120 performs collation on the captured image in order to detect an object. At this time, in the example of FIG. 5, it is assumed that it is determined that collation with a plurality of types of objects is matched with respect to the region of the tower on the captured image. In this case, the detection unit 120 may detect a plurality of types of objects in the region of the tower. Then, the identification unit 130 identifies the location information for each of the plurality of types of objects. Then, the estimation unit 140 may estimate the position of the notifying party for each of the plurality of types of detected objects. For example, it is assumed that objects “tower X” and “tower Y” are detected in the region of the tower in FIG. 5. In this case, the estimation unit 140 may estimate the position of the notifying party in a case where the region of the tower on the captured image is “tower X” and the position of the notifying party in a case where the region of the tower on the captured image is “tower Y”.

### Modification 4

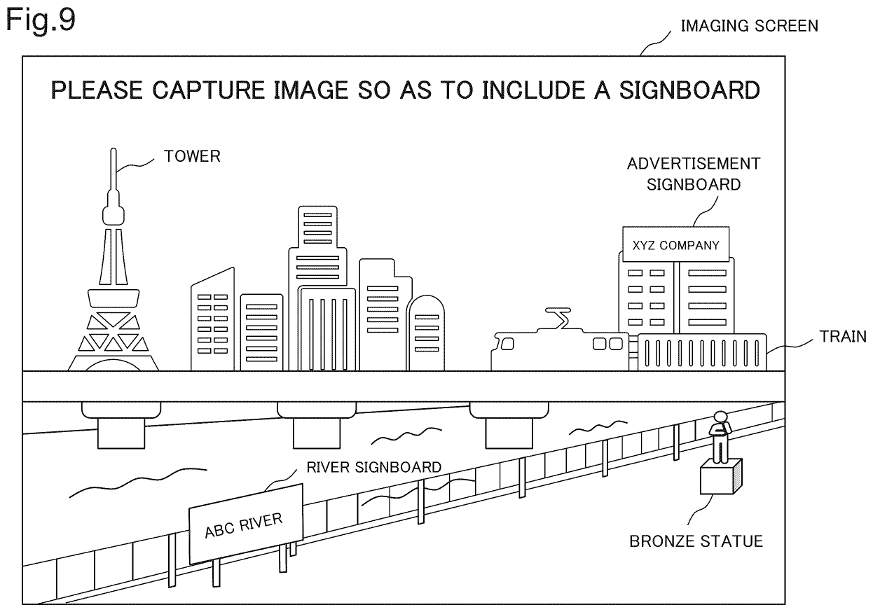

The imaging control unit 1101 may superimpose various types of information on the imaging screen of the communication terminal 20. The imaging screen is, for example, a screen displayed on a display or the like included in the communication terminal 20 when the communication terminal 20 captures an image. For example, the imaging control unit 1101 may display information for prompting imaging of a specific object on the imaging screen. FIG. 9 is a diagram illustrating an example of an imaging screen. As illustrated in FIG. 9, for example, the imaging control unit 1101 may display “Please perform imaging so as to include a signboard” on the imaging screen. As a result, the imaging control unit 1101 can prompt the notifying party to perform imaging so as to include the signboard. The object to be prompted to be captured as an image may not be a signboard. For example, the imaging control unit 1101 desirably prompts the detection unit 120 to capture an object that is easily detected. In this manner, the imaging control unit 1101 may superimpose the information indicating the object recommended as the imaging target on the imaging screen of the communication terminal 20.

### Modification 5

In a case where the direction information when the communication terminal 20 performs imaging can be acquired, the estimation unit 140 may estimate the position of the notifying party by further using the direction information.

The direction information is information indicating the direction in which the communication terminal 20 has been facing when the communication terminal 20 captures the image. For example, it is assumed that a sensor capable of measuring an azimuth, such as a magnetic sensor and a gyro sensor, is mounted on the communication terminal 20. At this time, the imaging unit 210 generates a captured image and acquires direction information indicating an azimuth at the time of imaging. Then, the imaging unit 210 transmits the captured image and the direction information to the notification assistance system 100. The captured image acquisition unit 1102 of the acquisition unit 110 acquires direction information including an azimuth at the time of imaging.

The estimation unit 140 estimates the position of the notifying party using the direction information. For example, it is assumed that the captured image of FIG. 5 is acquired and the location information is indicated as illustrated in FIG. 6. Here, it is assumed that the direction information indicates the northeast direction. This indicates that the notifying party has performed imaging while facing in the northeast direction. For example, assuming that the notifying party performs imaging at point A illustrated in FIG. 7A, the notifying party needs to perform imaging while facing in the east-southeast direction. Therefore, the estimation unit 140 can estimate that there is no notifying party near point A. On the other hand, if the imaging is performed from point B illustrated in FIG. 7B, the notifying party needs to perform imaging while facing in the northeast direction. Therefore, the estimation unit 140 can estimate that there is a high possibility that the notifying party is near point B.

In this manner, the notification assistance system 100 may acquire the direction information indicating the direction in which the communication terminal 20 has been facing when the communication terminal 20 captures the captured image, and may estimate the position of the notifying party by further using the direction information. As a result, the notification assistance system 100 can estimate the position of the notifying party more accurately.

### Third Example Embodiment

Next, a notification assistance system according to a third example embodiment will be described. In the third example embodiment, an example of another function of the notification assistance system will be described. The description of contents overlapping with the first and second example embodiments will be partially omitted.

### [Details of Notification Assistance System 101]

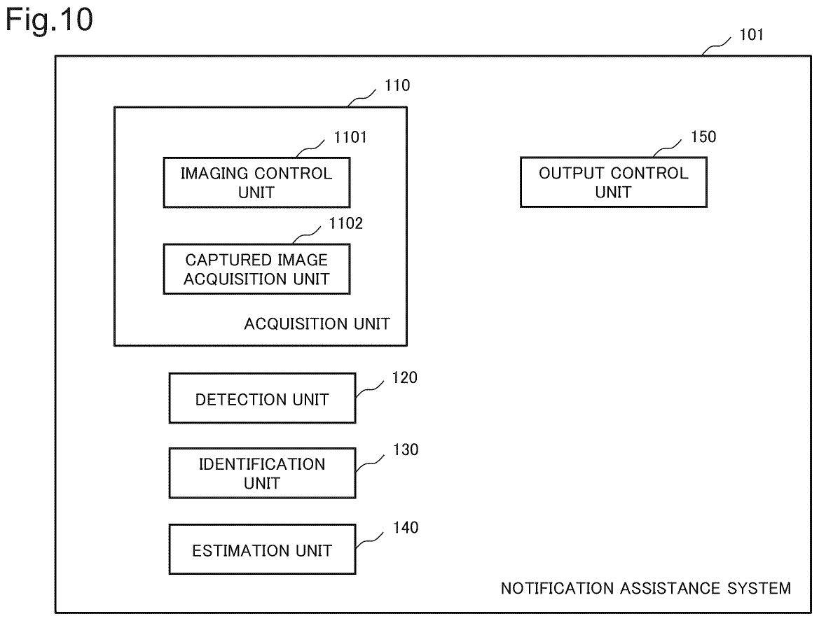

FIG. 10 is a block diagram illustrating an example of a functional configuration of a notification assistance system 101. The notification assistance system 101 may be included in the command system 10 instead of the notification assistance system 100 illustrated in FIG. 4. In the present example embodiment, an example in which the command system and the communication terminal 20 can communicate with each other as illustrated in FIG. 4, and the command system 10 includes the notification assistance system 101 will be described. The notification assistance system 101 may be incorporated in the communication terminal similarly to the notification assistance system 100, or may be a system implemented across the communication terminal 20 and the command system 10. The notification assistance system 101 may be implemented in a device different from the command system 10 that can communicate with the communication terminal 20. For example, the notification assistance system 101 performs processing described below in addition to the processing of the notification assistance system 100.

As illustrated in FIG. 10, the notification assistance system 101 includes an acquisition unit 110, a detection unit 120, an identification unit 130, an estimation unit 140, and an output control unit 150.

The output control unit 150 outputs various types of information. The output control unit 150 outputs various types of information to a display device such as a display that can be visually recognized by the operator in the command room, for example. The display device may be included in the command system 10, or may be included in a personal computer, a smartphone, a tablet, or the like communicably connected to the command system 10 or the notification assistance system 101. The output control unit 150 may output various types of information to a display device included in the communication terminal 20.

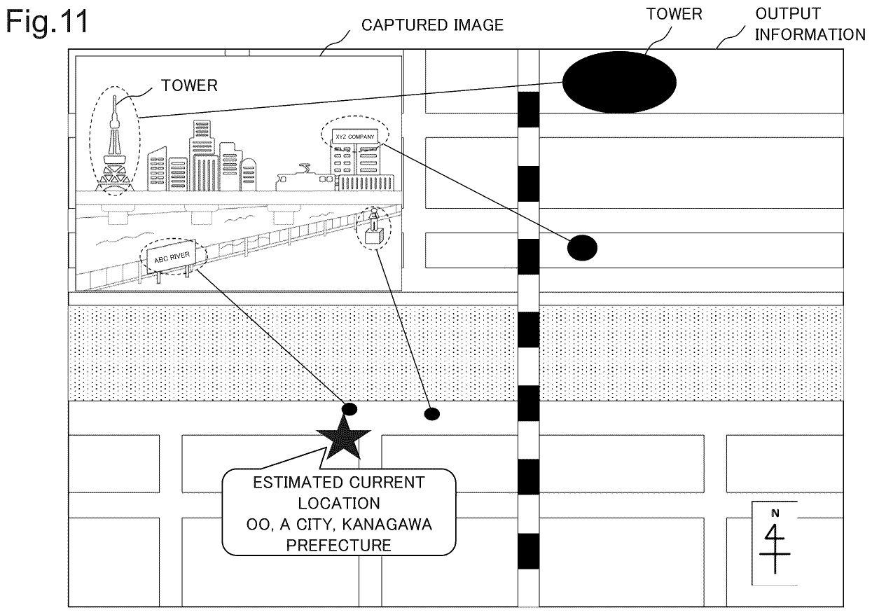

The output control unit 150 outputs, for example, information indicating the position of the notifying party estimated by the estimation unit 140. At this time, the output control unit 150 may output output information indicating the estimated position of the notifying party on the map. FIG. 11 is a diagram illustrating an example of output information. In the example of FIG. 11, a star-shaped mark indicating the estimated position of the notifying party is superimposed on the map. Further, in the output information, an address “00, A city, Kanagawa prefecture” is displayed as information indicating the position of the notifying party.

The output control unit 150 may output location information of a plurality of detected objects. At this time, the output control unit 150 may output output information indicating points indicated by the location information of the plurality of objects on the map. In the example of FIG. 11, points are superimposed at positions indicating points of the detected objects. Furthermore, the output control unit 150 may output output information in which each detected object on the captured image is associated with a point of the object shown on the map. For example, in FIG. 11, a line segment connecting a tower on the captured image and a position indicating the tower on the output information (that is, on the map) is illustrated.

In this manner, the output control unit 150 outputs, to the display device, the output information in which the estimated position of the notifying party and the point indicated by the location information are indicated on the map. Furthermore, the output control unit 150 may output, to the display device, information in which each of the plurality of objects on the captured image is associated with each of the points indicated by the location information in the output information. The output control unit 150 is an example of an output control means.

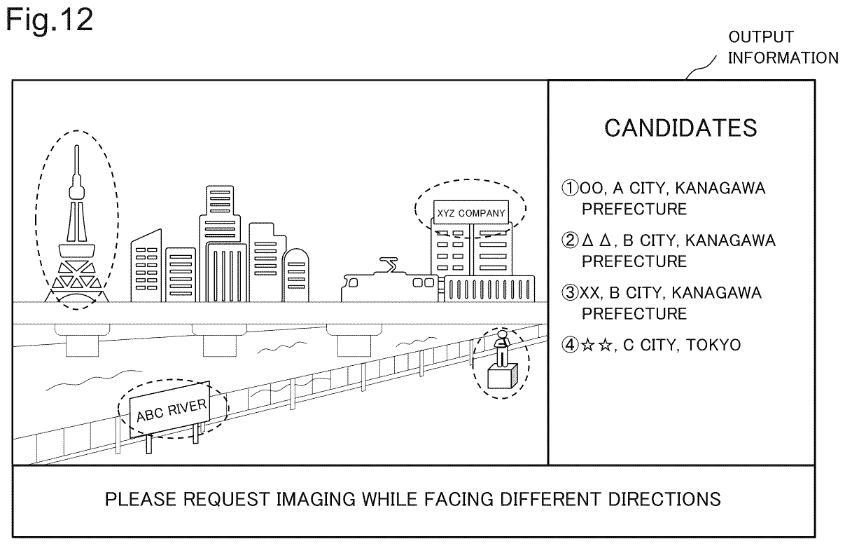

In a case where the position of the notifying party is not uniquely estimated, the output control unit 150 may output, to the display device, output information including information for prompting re-imaging. The case where the position of the notifying party is not uniquely estimated indicates a case where a plurality of positions of the notifying party are estimated or the position of the notifying party cannot be estimated. For example, it is assumed that a plurality of positions of the notifying party are estimated by the estimation unit 140. In this case, the output control unit 150 outputs information for prompting re-imaging to the display device. At this time, the output control unit 150 can cause the operator to request the notifying party to perform imaging by displaying information for prompting re-imaging on a display visually recognizable by the operator in the command room. The output control unit 150 can urge the notifying party to perform imaging by outputting information for prompting re-imaging to the communication terminal 20. FIG. 12 is a diagram illustrating another example of the output information. More specifically, FIG. 12 is an example of output information displayed on a display visually recognizable by the operator, the output information including information for prompting imaging. In the example of FIG. 12, the captured image and the four kinds of estimated position candidates of the notifying party are illustrated. Then, in FIG. 12, characters “Please request imaging while facing different directions” are illustrated. In this manner, the output control unit 150 may output, to the display device, information for prompting imaging from different directions. By visually recognizing such information, the operator can instruct the notifying party to perform re-imaging.

### [Operation Example of Notification Assistance System 101]

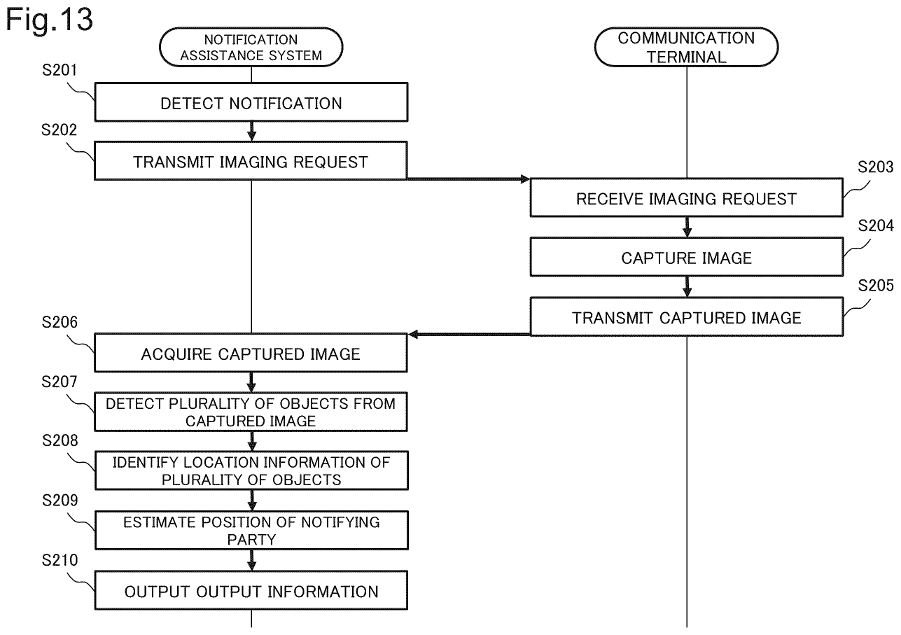

Next, an example of an operation of the notification assistance system 101 will be described with reference to FIG. 13.

FIG. 13 is a sequence diagram for explaining an example of the operation of the notification assistance system 101. Since the processing of S201 to S209 is similar to the processing of S101 to S109 of FIG. 8, description of the processing is omitted. The output control unit 150 outputs the output information based on the estimated position of the notifying party (S210). Here, in a case where the position of the notifying party is uniquely estimated, the output control unit 150 outputs, for example, output information in which the estimated position of the notifying party and the point indicated by the location information are indicated on a map.

In a case where the position of the notifying party is not uniquely estimated, the output control unit 150 outputs, for example, output information including information for prompting re-imaging to the display device. At this time, the imaging control unit 1101 may perform control to cause the communication terminal 20 to start re-imaging.

As described above, the notification assistance system 101 according to the third example embodiment outputs, to the display device, the output information in which the estimated position of the notifying party and the point indicated by the location information are indicated on the map, and the information in which each of the plurality of objects on the captured image and each of the points indicated by the location information in the output information are associated with each other. As a result, the notification assistance system 101 can cause the operator in the command room to grasp the estimated position of the notifying party, for example. Since the operator can grasp the information in which each of the plurality of objects on the captured image is associated with each of the points indicated by the location information in the output information, the notification assistance system 101 can more easily grasp the position of the notifying party.

In a case where the position of the notifying party is not uniquely estimated, the notification assistance system 101 according to the third example embodiment may output information for prompting re-imaging to the display device. As a result, the notification assistance system 101 can cause the operator to request the notifying party to perform imaging, for example. In a case where the information for prompting re-imaging is output to the communication terminal 20, the notification assistance system 101 can directly prompt the notifying party to perform re-imaging. At this time, the notification assistance system 101 may output information for prompting imaging from a different direction to the display device. As a result, the notification assistance system 101 can estimate the position of the notifying party again from the captured image in another direction.

### Modification 6

The notification assistance system 101 may estimate the position of the notifying party using further information. For example, the imaging unit 210 of the communication terminal 20 collects a background sound at the time of imaging. The background sound is a voice from around the communication terminal 20 at the time of imaging. The imaging unit 210 transmits the captured image and the background sound to the notification assistance system 101. The captured image acquisition unit 1102 of the acquisition unit 110 acquires the captured image and the background sound.

Then, the estimation unit 140 estimates the position of the notifying party by further using the background sound. For example, it is assumed that the estimation unit 140 estimates a plurality of places as candidates for the position of the notifying party. Here, in a case where the captured image illustrated in FIG. 5 is captured, the background sound includes a traveling sound of a train. For example, the estimation unit 140 estimates a place where there is a track in the vicinity among the plurality of estimated places as the position of the notifying party.

In this manner, the notification assistance system 101 may acquire the background sound when the communication terminal 20 captures the captured image and estimate the position of the notifying party by further using the background sound. As a result, the notification assistance system 101 can estimate the position of the notifying party more accurately.

### <Configuration Example of Hardware of Notification Assistance System>

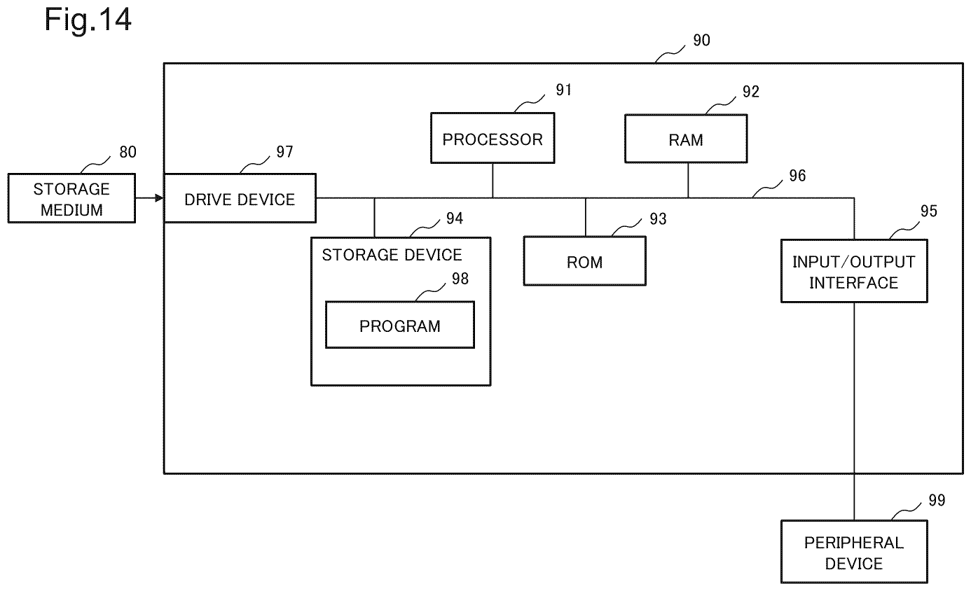

Hardware constituting the notification assistance systems according to the above-described first, second, and third example embodiments will be described. FIG. 14 is a block diagram illustrating an example of a hardware configuration of a computer device that implements the notification assistance system according to each example embodiment. In a computer device 90, the notification assistance system and the notification assistance method described in each example embodiment and each modification are achieved.

As illustrated in FIG. 14, the computer device 90 includes a processor 91, a random access memory (RAM) 92, a read only memory (ROM) 93, a storage device 94, an input/output interface 95, a bus 96, and a drive device 97. The notification assistance system may be implemented by a plurality of electric circuits.

The storage device 94 stores a program (computer program) 98. The processor 91 executes the program 98 of the present notification assistance system using the RAM 92. Specifically, for example, the program 98 includes a program that causes a computer to execute the processing described in FIGS. 3, 8, and 13. The processor 91 executes the program 98 to implement the functions of the components of the present notification assistance system. The program 98 may be stored in the ROM 93. The program 98 may be recorded in the storage medium 80 and read using the drive device 97, or may be transmitted from an external device (not illustrated) to the computer device 90 via a network (not illustrated).

The input/output interface 95 exchanges data with a peripheral device (keyboard, mouse, display device, etc.) 99. The input/output interface 95 functions as a means for acquiring or outputting data. The bus 96 connects the components.

There are various modifications of the method for implementing the notification assistance system. For example, the notification assistance system can be achieved as a dedicated device. The notification assistance system can be implemented based on a combination of a plurality of devices.

Processing methods for causing a storage medium to record a program for implementing components in a function of each example embodiment, reading the program recorded in the storage medium as a code, and executing the program in a computer are also included in the scope of each example embodiment. That is, a computer-readable storage medium is also included in the scope of each example embodiment. A storage medium in which the above-described program is recorded and the program itself are also included in each example embodiment.

The storage medium is, for example, a floppy (registered trademark) disk, a hard disk, an optical disk, a magneto-optical disk, a compact disc (CD)-ROM, a magnetic tape, a nonvolatile memory card, or a ROM, but is not limited to this example. The program recorded in the storage medium is not limited to a program that executes processing alone, and programs that operate on an operating system (OS) to execute processing in cooperation with other software and functions of an extension board are also included in the scope of each example embodiment.

While the invention has been particularly shown and described with reference to example embodiments thereof, the invention is not limited to above-described example embodiments. It will be understood by those of ordinary skill in the art that various changes in form and details may be made therein without departing from the spirit and scope of the present invention as defined by the claims.

The above-described example embodiments and modifications can be appropriately combined.

Some or all of the above example embodiments may be described as the following Supplementary Notes, but are not limited to the following.

### SUPPLEMENTARY NOTES

### Supplementary Note 1

A notification assistance system including:
an acquisition means for acquiring a captured image from a communication terminal owned by a notifying party;
a detection means for detecting a plurality of objects included in the captured image;
an identification means for identifying location information relevant to each of the plurality of detected objects; and
an estimation means for estimating a position of the notifying party based on the identified location information.

### Supplementary Note 2

The notification assistance system according to Supplementary Note 1, in which
the estimation means estimates a position of the notifying party based on a positional relationship of the identified location information and a positional relationship of the plurality of detected objects on the captured image.

### Supplementary Note 3

The notification assistance system according to Supplementary Note 2, in which
the acquisition means acquires direction information indicating a direction in which the communication terminal faces when the communication terminal captures the captured image, and
the estimation means estimates the position of the notifying party by further using the direction information.

### Supplementary Note 4

The notification assistance system according to any one of Supplementary Notes 1 to 3, in which
the estimation means estimates the position of the notifying party based on the positional relationship of the identified location information and information regarding a distance from the communication terminal to each of the plurality of objects, the information being extracted from the captured image captured by the communication terminal.

### Supplementary Note 5

The notification assistance system according to any one of Supplementary Notes 1 to 4, further including:
an output control means for outputting, to a display device, output information in which the estimated position of the notifying party and a point indicated by the location information are indicated on a map, and information in which each of the plurality of objects on the captured image and each of points indicated by the location information in the output information are associated with each other.

### Supplementary Note 6

The notification assistance system according to Supplementary Note 5, in which
in a case where the position of the notifying party is not uniquely estimated, the output control means outputs information for prompting re-imaging to a display device.

### Supplementary Note 7

The notification assistance system according to Supplementary Note 6, in which
the output control means outputs information for prompting imaging from different directions to a display device.

### Supplementary Note 8

The notification assistance system according to any one of Supplementary Notes 1 to 7, in which
the acquisition means acquires a background sound when the communication terminal captures the captured image, and
the estimation means estimates the position of the notifying party by further using the background sound.

### Supplementary Note 9

The notification assistance system according to any one of Supplementary Notes 1 to 8, in which
the acquisition means includes:
an imaging control means for causing the communication terminal to start imaging in response to detection of a notification from the communication terminal; and
a captured image acquisition means for acquiring, from the communication terminal, the captured image obtained by the started imaging.

### Supplementary Note 10

The notification assistance system according to Supplementary Note 9, in which
the imaging control means superimposes information indicating an object recommended as an imaging target on an imaging screen of the communication terminal.

### Supplementary Note 11

A notification assistance method including:
acquiring a captured image from a communication terminal owned by a notifying party;
detecting a plurality of objects included in the captured image;
identifying location information relevant to each of the plurality of detected objects; and
estimating a position of the notifying party based on the identified location information.

### Supplementary Note 12

A computer-readable storage medium storing a program causing a computer to execute:
acquiring a captured image from a communication terminal owned by a notifying party;
detecting a plurality of objects included in the captured image;
identifying location information relevant to each of the plurality of detected objects; and
estimating a position of the notifying party based on the identified location information.

### REFERENCE SIGNS LIST

10 command system
20 communication terminal
100, 101 notification assistance system
110 acquisition unit
120 detection unit
130 identification unit
140 estimation unit
150 output control unit
1101 imaging control unit
1102 captured image acquisition unit
210 imaging unit
220 request receiving unit

What is claimed is:

1. A notification assistance system comprising:
an acquisition circuit configured to acquire a captured image from a communication terminal owned by a notifying party;
a detection circuit configured to detect a plurality of objects included in the captured image;
an identification circuit configured to identify location information relevant to each of the plurality of detected objects; and
an estimation circuit configured to estimate a position of the notifying party based on the identified location information.

2. The notification assistance system according to claim 1, wherein
the estimation circuit estimates a position of the notifying party based on a positional relationship of the identified location information and a positional relationship of the plurality of detected objects on the captured image.

3. The notification assistance system according to claim 2, wherein
the acquisition circuit acquires direction information indicating a direction in which the communication terminal faces when the communication terminal captures the captured image, and
the estimation circuit estimates the position of the notifying party by further using the direction information.

4. The notification assistance system according to claim 1, wherein
the estimation circuit estimates the position of the notifying party based on the positional relationship of the identified location information and information regarding a distance from the communication terminal to each of the plurality of objects, the information being extracted from the captured image captured by the communication terminal.

5. The notification assistance system according to claim 1, further comprising:
an output control circuit configured to output, to a display device, output information in which the estimated position of the notifying party and a point indicated by the location information are indicated on a map, and information in which each of the plurality of objects on the captured image and each of points indicated by the location information in the output information are associated with each other.

6. The notification assistance system according to claim 5, wherein
in a case where the position of the notifying party is not uniquely estimated, the output control circuit outputs information for prompting re-imaging to a display device.

7. The notification assistance system according to claim 6, wherein
the output control circuit outputs information for prompting imaging from different directions to a display device.

8. The notification assistance system according to claim 1, wherein
the acquisition circuit acquires a background sound when the communication terminal captures the captured image, and
the estimation circuit estimates the position of the notifying party by further using the background sound.

9. The notification assistance system according to claim 1, wherein
the acquisition circuit includes:
an imaging control circuit configured to cause the communication terminal to start imaging in response to detection of a notification from the communication terminal; and
a captured image acquisition circuit configured to acquire, from the communication terminal, the captured image obtained by the started imaging.

10. The notification assistance system according to claim 9, wherein
the imaging control circuit superimposes information indicating an object recommended as an imaging target on an imaging screen of the communication terminal.

11. A notification assistance method comprising:
acquiring a captured image from a communication terminal owned by a notifying party;
detecting a plurality of objects included in the captured image;
identifying location information relevant to each of the plurality of detected objects; and
estimating a position of the notifying party based on the identified location information.

12. A tangible and non-transitory computer-readable storage medium storing a program causing a computer to execute:
acquiring a captured image from a communication terminal owned by a notifying party;
detecting a plurality of objects included in the captured image;
identifying location information relevant to each of the plurality of detected objects; and
estimating a position of the notifying party based on the identified location information.
